(19) United States
(12) Patent Application Publication
(10) Pub. No.: US 2010/0111645 A1
(43) Pub. Date: May 6, 2010

(54) Anthropomorphic force-reflective master arm

(76) Inventors: Mayez Al-Mouhamed, Dhahran (SA); Nesar Merah, Dhahran (SA)

Correspondence Address: LITMAN LAW OFFICES, LTD., POST OFFICE BOX 41200, SOUTH STATION, ARLINGTON, VA, 22204, US

(21) Appl. No.: 12/289,792

(22) Filed: Nov. 4, 2008

(51) Int. Cl. B25J 3/00; B25J 1/02

(52) U.S. Cl. 414/5; 901/21; 901/23

(57) ABSTRACT

The anthropomorphic force-reflective master arm controls a remote robotic arm and includes a plurality of rotatably joined mechanical links extending from a base to provide up to six degrees of freedom. Three of the link members are rotatably coupled to each other to form a handle, so that axes of rotation of each of the handle link members intersect at a user's hand position. Cable and pulley assemblies for the link joints are connected to their corresponding backdrive motors, the backdrive motors being disposed on the base to provide efficient transmission of forces experienced by the remote machine to the master arm handle.

### BACKGROUND OF THE INVENTION

1. Field of the Invention

The present invention relates to robotic control systems, and particularly to an anthropomorphic force-reflective master arm that allows a human operator to map his hand motion to a remote slave tool in unstructured environments in which autonomous robots cannot be used.

2. Description of the Related Art

It is often necessary that a human operator manually control the motion of a remote tool being held by an arbitrary slave device, e.g., a robotic arm manipulating a device outside a satellite in space, an underwater robotic arm, etc. The remote slave device is sometimes located in a hostile or unstructured environment, which justifies the need to keep the human operator in a safe remote location. The interconnection between the human interface system and the slave device is arbitrary, and may use a dedicated or public network. The interface is designed to permit the operator hand-operated translation and rotation of the control, and to transmit such changes to the slave device so that the changes are superimposed to a current tool position and orientation.

An improvement to this human interface would provide the capability to simultaneously measure all hand changes in position and orientation in order to minimize the number of iterations needed for tool set up in a desired configuration. Forces and torques exerted on the tool by a workpiece would be streamed from the slave device to reflect back on the operator's hand. The interface must provide force feedback to let the operator feel the forces displayed on its motors. An increased force feedback gain is desired to provide acceptable fidelity and sensitivity to small force/torque feedback magnitudes because the interface inertia felt at the operator hand must be very small.

Thus, an anthropomorphic force-reflective master arm solving the aforementioned problems is desired.

### SUMMARY OF THE INVENTION

The anthropomorphic force-reflective master arm is a lightweight, backdrivable, six degree of freedom robotic arm that can serve as a master arm to control the motion of a remote slave arm. The master arm includes up to six serially connected rotary joints that extend from a grounded base to a handle that can be grasped and manipulated by an operator. The grounded base houses six motors. The position of operator hand origin depends only on the first three rotary joints (nearest to the base). The last three rotary joints (nearest to the handle) have concurrent rotation axes that intersect at the operator hand origin and are used for rendering the rotation of the operator's hand.

A lightweight, balanced mechanism is used for the last three rotary joints, which are arranged to directly measure operator forearm rotation, operator horizontal elevation, and operator vertical elevation, respectively. The operator feels the same impedance in all rotational directions due to the balanced mechanism in the last three rotary joints, which improves force feedback fidelity. This arrangement uncouples hand translation from hand orientation.

Since the motors are grounded at the base, a back drivable transmission uses pre-tensioned cable and lightweight pulleys to connect each motor to its corresponding joint. The fidelity and reversibility of the transmission mechanism facilitates the display of kinesthetic force feedback on the operator hand. The master arm provides a singularity-free mechanism to render the operator hand motion and map it to a remote tool while providing a high fidelity kinesthetic force display. The master arm weighs three kilograms, has more than one cubic meter of work envelope, and has better similarity to the human arm than previous designs.

Sensors determine movement of the handle and transmit corresponding signals to a control computer. The control computer maps movement of the handle to a remote slave arm. Similarly, sensors at the remote slave arm determine reactive forces resulting from the mapped movement of the slave arm and transmit corresponding signals to the control unit. The control unit sends corresponding signals to activate the motors at the base of the master arm to reflect the forces encountered by the slave arm to the handle, so that the operator senses reaction of the workpiece to movement of the slave arm as though the operator were manipulating the slave arm directly.

These and other features of the present invention will become readily apparent upon further review of the following specification and drawings.

### BRIEF DESCRIPTION OF THE DRAWINGS

FIG. 1 is a perspective view of an anthropomorphic force-reflective master arm according to the present invention, the cables being omitted for clarity.

FIG. 2 is a schematic view of the cable interlink transmission and motor configuration of the anthropomorphic force-reflective master arm according to the present invention.

FIG. 3 is a perspective view of a cable guide system for degrees of freedom 4, 5 and 6 of an anthropomorphic force-reflective master arm according to the present invention.

Similar reference characters denote corresponding features consistently throughout the attached drawings.

### DETAILED DESCRIPTION OF THE PREFERRED EMBODIMENTS

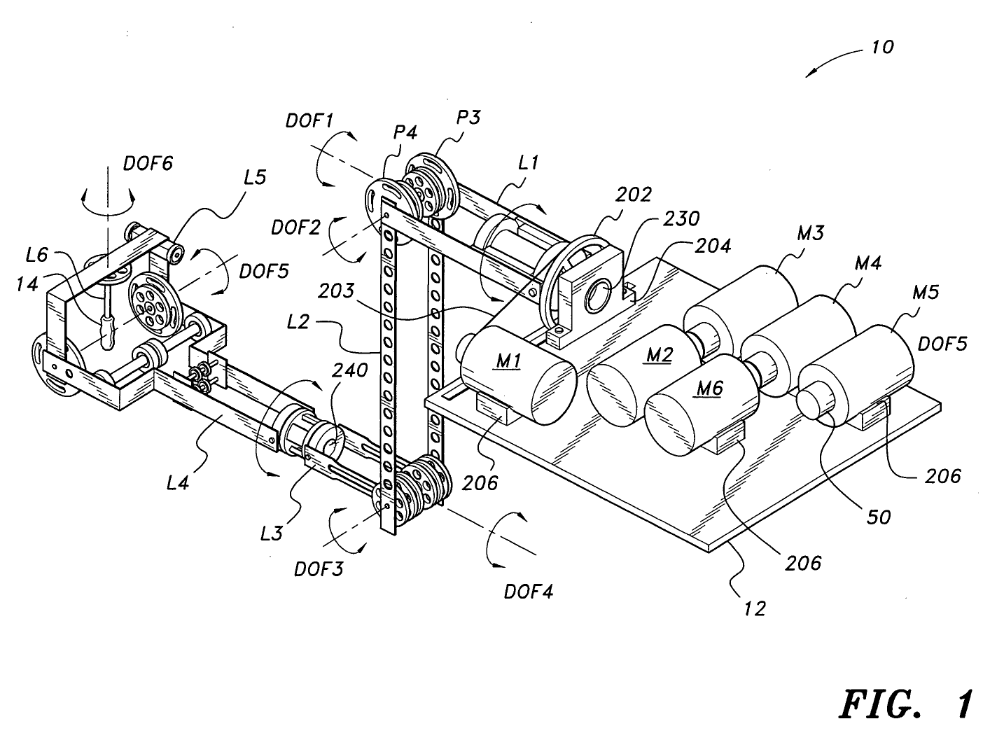

As shown in FIG. 1, the present invention relates to an anthropomorphic force-reflective robotic master arm (AFRMA) 10 that includes a plurality of links serially connected at rotary joints. The arm 10 extends from a base 12 to a handle 14 in a fashion similar to a human arm. A plurality of motors M1 through M6 are disposed on the base 12 by mounting blocks 206 to generate force/torque components according to feedback from a slave (remote) arm. Location of the motors M1 through M6 on the base 12 instead of at the rotational link joints improves the responsiveness of the arm 10.

The master arm 10 is sampled at regular time intervals by sensors connected to a control computer. Cartesian changes in operator hand position and orientation are transmitted to the control computer to map movement of a slave arm that may be kinematically different from the master arm 10. All six rotatable joints are mechanically decoupled from each other and have no backlash due to the pre-tensioned transmission cables. A remote slave arm can respond by a motion that is a replica of operator hand motion driving the master arm 10.

The motors M1-M6 of master arm 10 include threaded rollers 50 and are disposed on the fixed platform 12 to improve the dynamics of master arm 10. Transmission cables interconnect motors M1-M6 to pulleys at rotational joints DOF1-DOF6. To the extent practicable, the transmission cables associated with a first link having a specific rotational DOF extend near a rotation axis of a second, interconnected link in order to decouple rotation of the first link from rotation of the second, interconnected link. As shown in FIG. 1, the first L1 and fourth L4 links exemplify the aforementioned decoupled configuration.

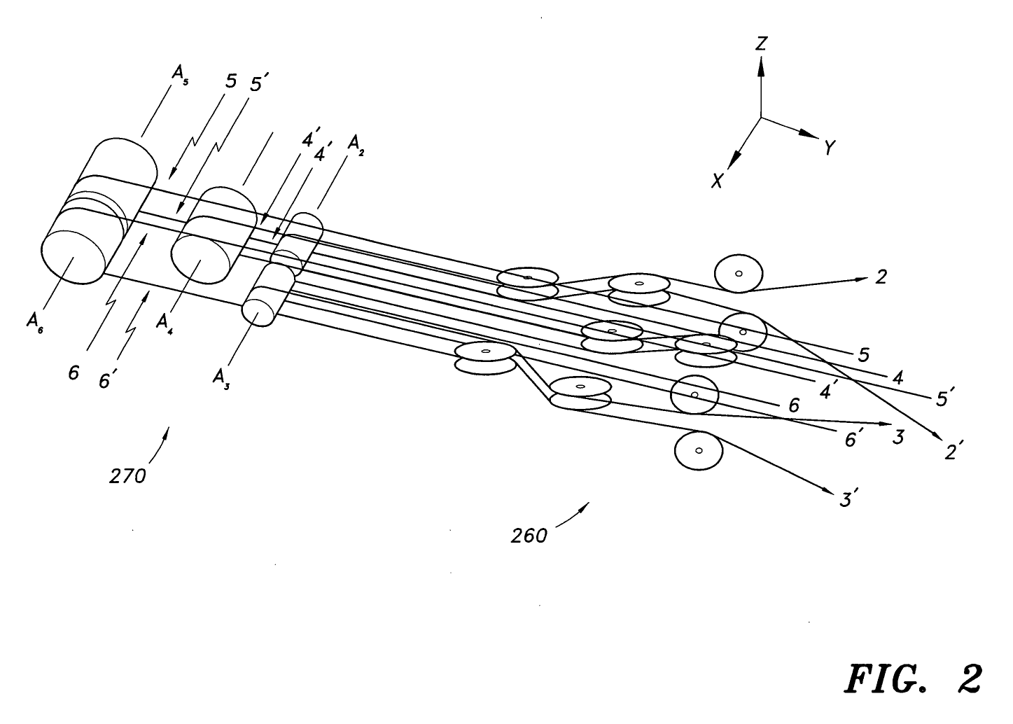

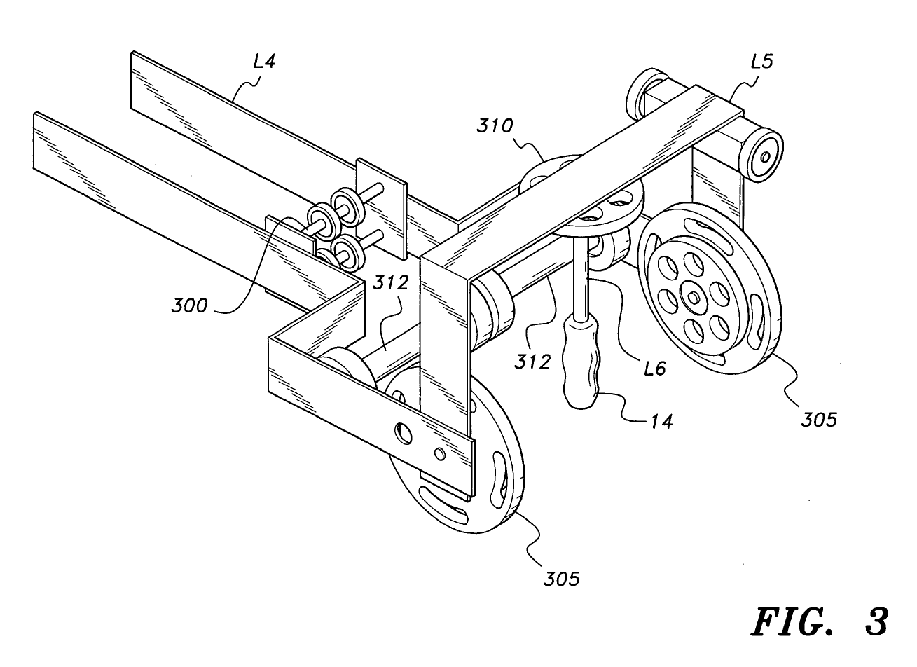

Again referring to FIG. 1, a reducer pulley 202 is mounted on link L1 and connected to motor M1 using a flexible steel rope 203. In the configuration shown, link L1 has a hollow cylinder 230 extending axially between the link sidearms. Ten cables extend through cylinder 230 to drive the five links L2 through L6. FIG. 2 shows a cable orientation schematic for an interlink transmission 260 comprising the ten cables (2, 2′, 3, 3′, 4, 4′, and 5, 5′), which are connected to threaded roller group A2 through A6 of motor group 270. Moreover cables 6, 6′ are associated with DOF6 and connected to pulley 310, which is shown in FIG. 3. A low friction pulley mechanism is used to guide the cables 2 through 5′ from the motor rollers A₄-A₆ to the interlink transmission, more particularly, to small-dimensioned pulleys at each of the DOF1-DOF6 rotational joints. A configuration similar to cylinder 230 is provided to traverse the fourth link L4. The pulley-drive orientation, which includes threaded wheels P3 and P4, ensures the independence between the rotation of link L1 and the subsequent five links L2-L6.

The motor-link transmission 260 is based on a cable-pulley configuration that extends from a motor (one of M2-M6) to a link (one of L2-L6) through the hollow cylinders 230 and 240, while uncoupling the transmitted motion from that of the traversed link. The motor-link transmission 260 is based on the cables 2 through 5′ being of a multiple, independent closed-loop variety. The connectivity between a motor (one of M1-M6) and a link (one of L1-L6) is achieved through multiple Cable Pulley Loop (CPL) mechanisms. Each CPL is an independent system. The transmission from motor to link is then achieved using an arbitrary subset of attached (pulley level) CPLs. The first loop L1 transmits motion from the motor M1 to the first link L1 (DOF1). In this and all other links, speed reduction is performed as close as possible to the intended driven link.

Each loop starts with a threaded roller mounted on the electric motor shaft. The transmission wire is freely wrapped three times around the roller along a machined deep thread. The thread pitch and depth are selected according to the rope diameter. Embedding the wire in the thread will practically eliminate slippage. Both ends of the rope are wrapped around the driven threaded wheel. Each wire is wrapped two times around the wheel (pulley) to provide an acceptable range of motion (ROM) at the end link. In the final wrap, the rope is introduced through a specially designed inclined through-hole to be completely restrained from any slippage by a tightening screw device (not shown).

The first link L1 and the second link L2 are driven by a single loop each. The following links (L2 through L6) are driven by L1 cable pulley loop assemblies (CPLs). In this manner, the loops remain independent to reduce physical effort required to maintain the master arm 10 in a localized area, and to improve system reliability. Pre-tensioning the wire is done independently for each loop. The independent pre-tensioned configuration of wires for each loop (CPL) allows a high-speed, low (force) tension cable to be used for the first n−1 CPL's and, finally, a high (force) tension wire is used for the n^{th} CPL connected to the corresponding link.

Due to the aforementioned configuration of drive motors M1 through M6 and transmission cables 203, 2, 2′, 3, 3′, 4, 4′, 5, 5′, and 6,6′, the master arm 10 has low friction, low inertia, and low mass. The motors M1-M6 are disposed on the stable platform 12 to eliminate the potential of damaging the master arm 10 due to excess weight and inertia. Arm fidelity is improved to thereby more accurately transmit a reflected force feedback. Mounting all of the motors M1 through M6 on base 12 provides maximum possible force/torque dynamics, as well as enlarging the force transmission bandwidth. The force/torque vector exerted on a slaved tool is sensed by a force sensor, which is generally installed at the wrist of the slave arm. The sensed vector is used to compute the force/torque vector exerted on the slaved tool. The tool force/torque vector is sampled and transmitted at regular time intervals (streamed) to the master arm station, where it is converted into a motor torque vector that reproduces the tool force/torque vector at the operator hand center 14. This allows the operator to feel the force/torque that is proportional to the one exerted on the remote tool.

As most clearly shown in FIG. 3, the L5 and L6 link members have associated pulleys 305 and 310, respectively. A user's hand grabs L6, which is a vertical member rotatably attached to and extending from L5. L6 is responsive to a twist (yaw) motion of the hand, while pivotal bracket-shaped link L5 is responsive to a pitch motion of the user's hand. Cable guides 300 are disposed on L4 and are threaded onto threaded receivers 312, making L4 responsive to a rotation (roll) of the user's hand.

It is to be understood that the present invention is not limited to the embodiment described above, but encompasses any and all embodiments within the scope of the following claims.

We claim:

1. An anthropomorphic force-reflective master arm, comprising:
a base;
a plurality of backdrive motors disposed on the base including a first degree of freedom backdrive motor, the backdrive motors providing backdrive response to forces encountered by a remote slave arm for each degree of freedom of the master arm;
threaded rollers disposed on the backdrive motors;
force transmission cables disposed on the threaded rollers;
a plurality of link members having joints independently and rotatably joining the link members to each other, including a first link member rotatably attached to the base;
a plurality of pulleys, at least one of the pulleys being disposed in a corresponding one of the link member joints, the force transmission cables being attached to the pulleys;
at least one flexible transmission member interconnecting the first link member to the first backdrive motor, the first backdrive motor providing backdrive torque to the first link member to rotate the first link member about a first degree of freedom; and
a hand grip disposed at a junction of three of the link members, the three link members being independently rotatably coupled to each other and forming handle link members, wherein an axis of rotation of each of the three handle link members intersects at a user's hand position, each of the three handle link members being connected to a corresponding one of the plurality of backdrive motors, the corresponding backdrive motor providing backdrive torque that the user can sense at the handle.

2. The anthropomorphic force-reflective master arm according to claim 1, wherein said link members form a six degree of freedom system, degrees four, five, and six corresponding to the three handle link members the three handle link members being link members four, five, and six, respectively, the plurality of link members including;
a second link member pivotally connected to the first link member to form a second degree of freedom; and
a third link member extending from the fourth link member and being pivotally connected to the second link member to form a third degree of freedom.

3. The anthropomorphic force-reflective master arm according to claim 1, wherein the transmission cables are pre-tensioned.

4. The anthropomorphic force-reflective master arm according to claim 1, wherein the transmission cable associated with the first link has a rotational degree of freedom extending near a rotation axis of the second link to decouple rotation of the first link from rotation of the second link.

5. The anthropomorphic force-reflective master arm according to claim 1, further comprising a second hollow cylinder, the second hollow cylinder connecting link members three and four, thereby allowing extension of cables for degrees of freedom five and six.

6. The anthropomorphic force-reflective master arm according to claim 1, further comprising: a hollow cylindrical core extending through a longitudinal axis of the first link member, a plurality of the transmission cables extending therethrough.

7. The anthropomorphic force-reflective master arm according to claim 1, wherein the transmission cable connections to the pulleys are multiple, independent, and closed loop to form a cable pulley loop (CPL) mechanism.

8. The anthropomorphic force-reflective master arm according to claim 1, further comprising a machined deep thread disposed on each threaded roller, the machined deep thread accepting a transmission cable end wire wrapped three times around the roller.

9. The anthropomorphic force-reflective master arm according to claim 8, wherein a remaining end wire of the transmission cable is disposed with a 2× wrap around a threaded wheel at a corresponding joint, yielding a predetermined minimum range of motion at the associated link, the end of the wire being locked within the threaded wheel.
